(19) United States
(12) Patent Application Publication
(10) Pub. No.: US 2020/0074694 A1
(43) Pub. Date: Mar. 5, 2020

(54) COLOR CONVERSION DEVICE, COLOR CONVERSION METHOD, AND COLOR CONVERSION PROGRAM

(71) Applicant: KONICA MINOLTA, INC., Tokyo (JP)

(72) Inventor: Toshiki TSUKANO, Hino-shi, Tokyo (JP)

(73) Assignee: KONICA MINOLTA, INC., Tokyo (JP)

(21) Appl. No.: 16/534,103

(22) Filed: Aug. 7, 2019

(30) Foreign Application Priority Data
Sep. 3, 2018 (JP) 2018-164326

(51) Int. Cl. G06T 11/00; G06T 7/90; G06T 7/70

(52) U.S. Cl. CPC G06T 11/001; G06T 7/70; G06T 7/90

(57) ABSTRACT

A color conversion device that applies a profile to a target image to perform color conversion includes a hardware processor that receives specification of a color to be corrected in a target image, adjusts the color that has been specified in a profile, and modifies an adjustment amount for surroundings of the color that has been specified, in accordance with the target image.

The entire disclosure of Japanese patent Application No. 2018-164326, filed on Sep. 3, 2018, is incorporated herein by reference in its entirety.

### BACKGROUND

### Technological Field

The present invention relates to a color conversion device, a color conversion method, and a color conversion program that perform color conversion by applying a profile to a target image.

### Description of the Related Art

When color adjustment is performed, for example, for a display of a print image or a display on a display part, there are cases where color specification in an image is desired for correction. For example, in order to correct a specified color as mentioned above when color conversion using an international color consortium (ICC) profile is performed, the specified color can be corrected by giving a correction amount to grids surrounding the specified color among grids in the ICC profile.

However, when the correction is made as mentioned above, the influence range of the correction sometimes extends to colors not desired to be corrected, causing a problem that the correction is not properly performed as expected.

Meanwhile, a spot color function is known as a method of correcting a particular color; when a spot color is used, however, it is necessary to embed spot color information in an image with a desk top publishing (DTP) application (such as Photoshop (trademark)) and, after the image is output once, it is required to return to the DTP application to match colors, which is very time-consuming.

For example, JP 2010-114532 A discloses a method of adjusting an output value by giving an adjustment amount substantially equal to an amount desired for adjustment, to grids that interpolate an adjustment target color.

However, in the method proposed in JP 2010-114532 A, although the method of exerting the influence on surrounding grids is described, a method of maintaining a color not desired to be corrected or a method of making pinpoint correction is not mentioned, and a problem remains in that appropriate correction is not suitably made if a correction color conflicts with a color not desired to be corrected.

### SUMMARY

The present invention has been made against the background situation described above, and aims to provide a color conversion device, a color conversion method, and a color conversion program capable of correcting a color desired to be corrected into an expected correction value and reducing the influence on a color not desired to be corrected.

To achieve the abovementioned object, according to an aspect of the present invention, there is provided a color conversion device that applies a profile to a target image to perform color conversion, and the color conversion device reflecting one aspect of the present invention comprises: the color conversion device comprising a hardware processor that receives specification of a color to be corrected in a target image, adjusts the color that has been specified in a profile, and modifies an adjustment amount for surroundings of the color that has been specified, in accordance with the target image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating control blocks of a color conversion device according to an embodiment of the present invention;

FIG. 2 is a diagram illustrating control blocks of a color conversion device according to another embodiment;

FIG. 3 is a diagram illustrating an adjustment screen for manually making correction;

FIG. 4 is a diagram illustrating an adjustment screen for making correction by sample registration;

FIG. 5 is a diagram illustrating a first pattern of the conflict between a correction color and non-correction colors;

FIG. 6 is a diagram illustrating a second pattern of the conflict between a correction color and non-correction colors;

FIG. 7 is a diagram illustrating a third pattern of the conflict between a correction color and non-correction colors;

FIG. 8 is a flowchart illustrating a procedure for reducing the correction amount in the case of the conflict between the correction color and the non-correction color;

FIG. 9 is a diagram illustrating a specific example of reducing the correction amount;

FIG. 10 is a flowchart illustrating a procedure for adjusting the number of grids in the case of the conflict between the correction color and the non-correction color;

FIG. 11 is a diagram illustrating an example of adding grids for the correction color and the non-correction color;

FIG. 12 is a diagram illustrating an example of performing smoothing on the entire grids;

FIG. 13 is a flowchart illustrating a procedure for adding a grid group in the case of the conflict between the correction color and the non-correction color;

FIG. 14 is a diagram illustrating an example of adding a grid group that interpolates the correction color and a grid group that interpolates the non-correction color;

FIG. 15 is a flowchart illustrating a procedure for designating whether to add a grid, according to additional information on the non-correction color;

FIG. 16 is a flowchart illustrating a procedure for making correction in accordance with a threshold value as to whether or not the influence is acceptable; and

FIG. 17 is a flowchart illustrating a procedure for designating the non-correction color from information in an image.

### DETAILED DESCRIPTION OF EMBODIMENTS

Hereinafter, one or more embodiments of the present invention will be described with reference to the drawings. However, the scope of the invention is not limited to the disclosed embodiments.

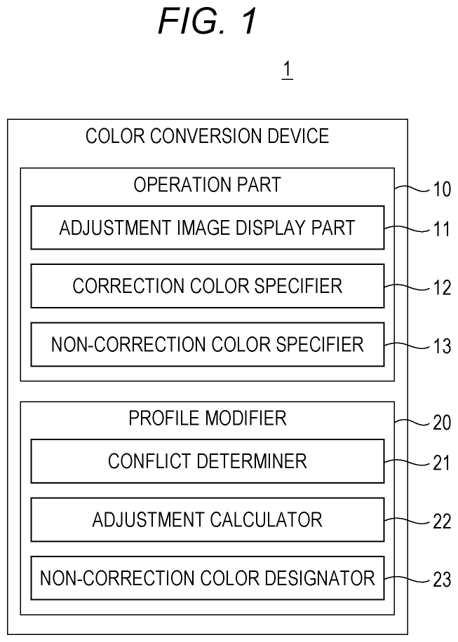

A color conversion device 1 illustrated in FIG. 1 has an operation part 10 and a profile modifier 20 as main components.

The operation part 10 is a device that accepts an operator's operation input, and includes a display part. The display part has an adjustment image display part 11 and displays an image to be adjusted. A liquid crystal display (LCD) or the like can be used as the display part, but the display part is not limited to a particular device.

The operation part 10 has a correction color specifier 12 and a non-correction color specifier 13. The correction color and the non-correction color can be acquired from the original image. In addition, the correction color may be a spot color (special color). For example, the correction color may be a color defined as a special color, such as a corporate color or a color in line with DIC (trademark) or PANTONE (trademark). The same is true for the non-correction color.

The correction color specifier 12 specifies a color to be corrected in the target image. A mouse, a tablet, or the like may be used for the correction color specifier 12, or alternatively, the adjustment image display part 11 may be formed as a touch panel such that the specification operation can be made on the screen.

Similarly to the correction color specifier 12, a mouse, a tablet, or the like may be used for the non-correction color specifier 13, or alternatively, the adjustment image display part 11 may be formed as a touch panel such that the specification operation can be made on the screen. Furthermore, in the non-correction color specifier, the setting of the degree of importance may be enabled for the non-correction color, and the setting of different degrees of importance may be enabled for different non-correction colors.

For various conditions described above, whether or not determination is made on whether or not the correction color and the non-correction color conflict with each other in the influence range of correction can be employed as one of the conditions.

The profile modifier 20 has a conflict determiner 21, an adjustment calculator 22, and a non-correction color designator 23.

The profile modifier 20 is configured from, for example, a central processing unit (CPU), programs working on the CPU, and a storage part constituted by a read only memory (ROM), a random access memory (RAM), and other non-volatile memories. The programs include a color conversion program according to the present invention. The profile modifier 20 acquires the specification result of the correction color or the non-correction color specified by the operation part 10.

The conflict determiner 21 is included in a part of the profile modifier 20 and determines whether or not the non-correction colors conflict with the correction color in the influence range due to the correction of the correction color in the target image. In addition to whether or not the influence is exerted, the extent of the influence may be assigned in advance as a threshold value such that whether there is a conflict is determined depending on whether or not the threshold value is exceeded.

The adjustment calculator 22 sets an adjustment amount for the surroundings of the specified color. This adjustment amount is set for adjustment of the surroundings of the specified color determined by the conflict determiner 21. At this time, in the case of a color or a region for which the degree of importance has been set by the non-correction color specifier, the extent of adjustment can be set in consideration of the setting such that the influence of the specified color that has been corrected is eliminated or reduced in a range having a high degree of importance.

The adjustment amount may be manually input or may be automatically calculated from the color difference with sample data registered by a user.

The non-correction color designator 23 automatically designates, that is, specifies a non-correction color based on the specified color to be corrected. At this time, when the degree of importance has been set by the non-correction color specifier, the non-correction color may be designated in consideration of the degree of importance. The adjustment calculator 22 can calculate adjustment in accordance with the designation by the non-correction color designator 23. Note that, when the specification has been made by the non-correction color specifier 13 of the operation part 10, the designation by the non-correction color designator 23 may not be made.

The profile modifier 20 modifies the profile based on the adjustment amount calculated by the adjustment calculator 22. Although an ICC profile can be exemplified as a profile, the profile in the present invention is not limited to the ICC profile.

The color conversion device 1 may be, for example, incorporated in an image forming device, or may be provided outside the image forming device, in which case a server or a terminal may include the color conversion device 1 or the color conversion device 1 may be formed as an independent device.

In the above explanation, the color conversion device 1 is described as including at least the operation part 10 and the profile modifier 20; however, the color conversion device may be configured as including the profile modifier 20 without including the operation part 10.

In the present embodiment, the operation part and the profile modifier are prepared, and the operation part and the profile modifier may be equipped in the same device or in different devices that communicate via a network.

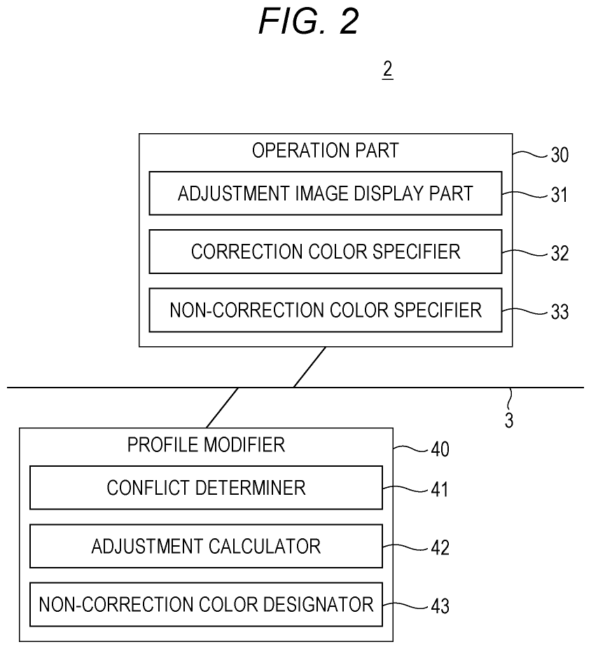

FIG. 2 illustrates a color conversion device 2 according to another mode.

In this embodiment, an operation part 30 and a profile modifier 40 can communicate via a network 3. The operation part 30 includes an adjustment image display part 31, a correction color specifier 32, and a non-correction color specifier 33. The profile modifier 40 includes a conflict determiner 41, an adjustment calculator 42, and a non-correction color designator 43. Each part can be configured similarly to each part of the color conversion device 1, and the detailed description thereof will be omitted.

In this embodiment, the operation part 30 and the profile modifier 40 may be included in the color conversion device 2, or alternatively, the profile modifier 40 may be included in the color conversion device 2 while the operation part 30 is not included in the color conversion device 2.

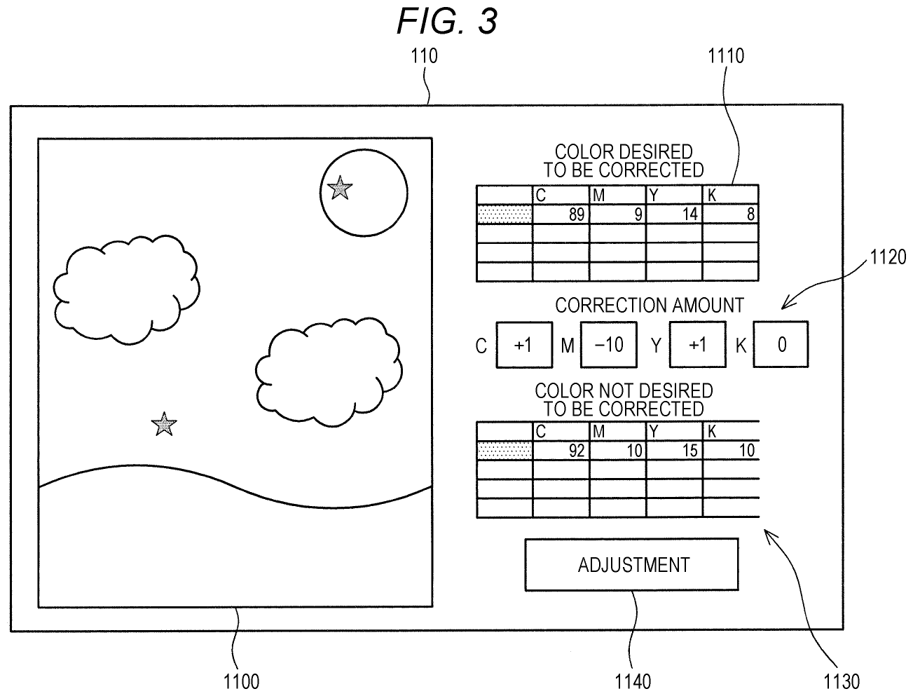

Next, an example of the adjustment image display part will be described based on FIG. 3.

The adjustment image display part 110 in FIG. 3 has a target image display part 1100, a correction color information part 1110 that displays information on a color desired to be corrected, and a correction amount inputter 1120 for the correction color. The adjustment image display part 110 further has a non-correction color information part 1130 that displays information on a color not desired to be corrected. An adjustment button 1140 executes adjustment when pressed.

In the target image display part 1100, the image to be adjusted is displayed as a preview and, when the adjustment is made, the adjusted image is displayed on the target image display part 1100.

A color specified on the preview is displayed in the list (correction color information part 1110) of colors desired to be corrected (correction colors) or the list (non-correction color information part 1130) of colors not desired to be corrected (non-correction colors), and adjustment can be made based on the correction amount 1120.

The non-correction color may be manually specified or may be automatically designated from the image. In the case of automatic designation, colors at positions other than the position where the correction color is specified are confirmed and automatically detected under a predetermined condition. At this time, the user may manually select a range as a range for searching for the non-correction color from the image.

In the adjustment image display part 110, adjustment can be made by manually inputting the correction amount. Besides this procedure, adjustment may be made with the automatically obtained correction amount.

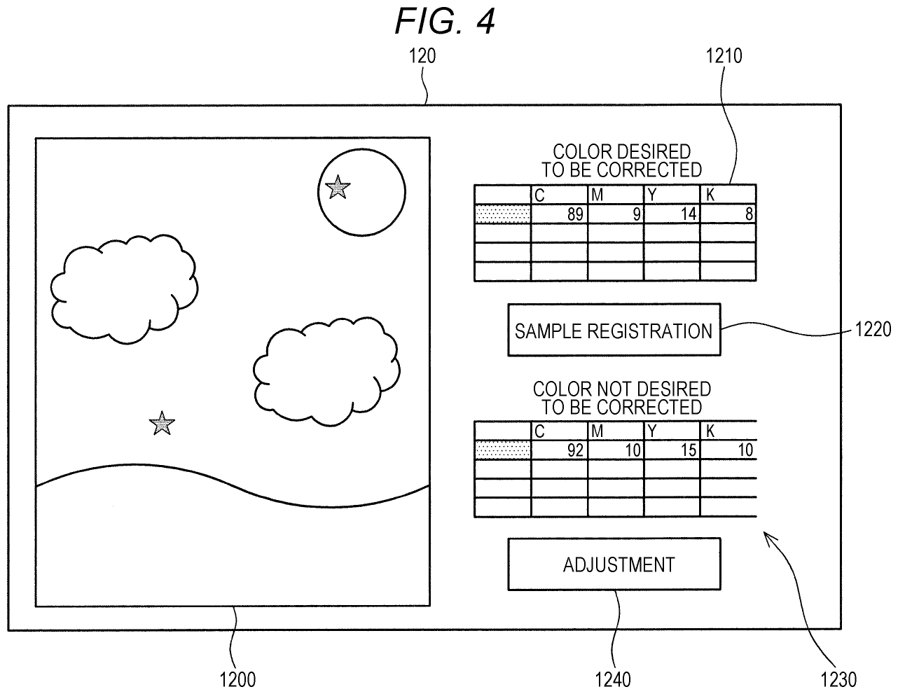

The adjustment image display part 120 in FIG. 4 has a target image display part 1200, a correction color information part 1210 that displays information on a color desired to be corrected, and a sample registration field 1220 for setting the correction color. The adjustment image display part 120 further has a non-correction color information part 1230 that displays information on a color not desired to be corrected. An adjustment button 1240 executes adjustment when pressed.

In the target image display part 1200, the image to be adjusted is displayed as a preview and, when the adjustment is made, the adjusted image is displayed on the target image display part 1200.

A color specified on the preview is displayed in the list (correction color information part 1210) of colors desired to be corrected (correction colors) or the list (non-correction color information part 1230) of colors not desired to be corrected (non-correction colors). In sample registration, a registered color sample can be selected. The correction amount is automatically designated by this sample.

In FIGS. 3 and 4, the user interface for correcting the CMYK values is assumed, but the user interface may be formed for another color space such as RGB or L*a*b*.

Next, the conflict between the correction color and the non-correction color will be described.

The conflict between the correction color and the non-correction color means that the correction range of the correction color includes the non-correction color, and has several patterns.

(1) Case of First Pattern in which No Grid of Correction Color Exists

When the correction color is corrected, it is necessary to correct a grid that interpolates the correction color. In that case, when there is a conflict with a color interpolated by the above-mentioned interpolating grid, or in one or more grids used for interpolation, a conflict is produced in correction.

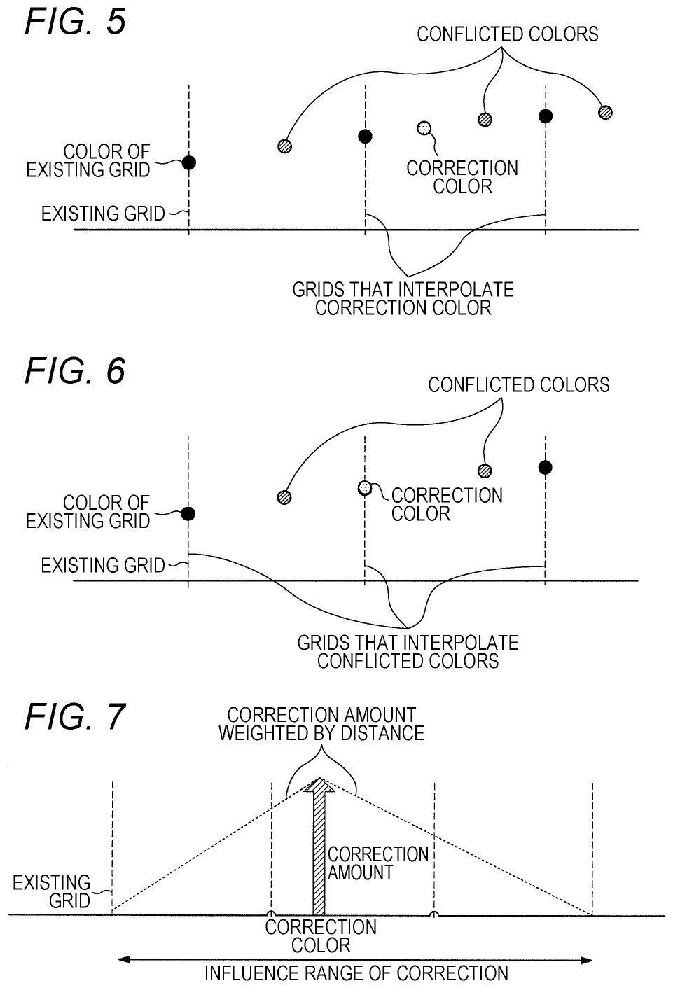

As illustrated in FIG. 5, when there are conflicted colors around the correction color, grids are provided around the conflicted colors to interpolate the correction color in addition to the existing grid. The interpolating grid is provided on a closer side to the correction color than the existing grid.

(2) Case of Second Pattern in which Grid of Correction Color Exists

A conflict is produced in correction when the non-correction color is interpolated using the grid of the correction color.

As illustrated in FIG. 6, grids that interpolate conflicted colors are used by utilizing the grid of the correction color.

(3) Case of Third Pattern in which Correction Range of Correction Color is Wider

Generally, when correction is made, correction is intended to apply the correction amount to a certain range to avoid tone jump.

As a technique, a correction amount is supplied by smoothing or weighting in accordance with the distance from the correction color. When the certain range contains the non-correction color, a conflict will be produced in correction.

The example illustrated in FIG. 7 uses a correction amount weighted by the distance.

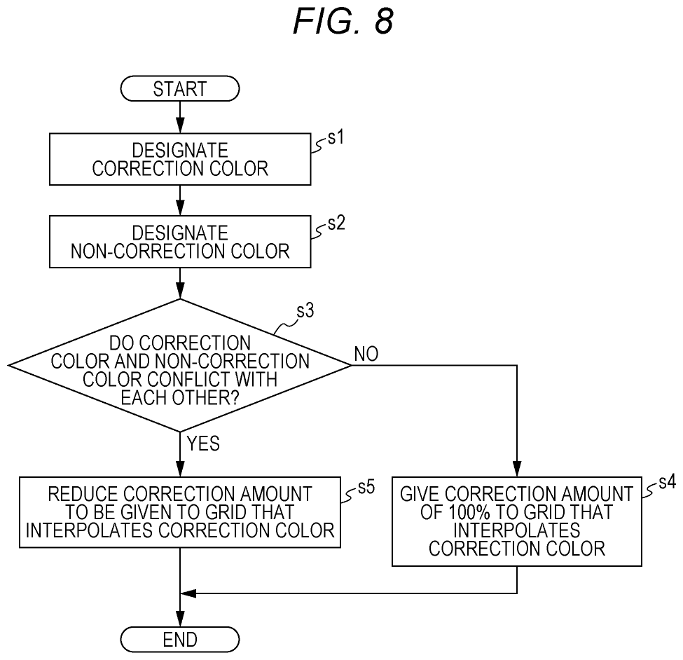

Next, a procedure for reducing the correction amount of a grid according to whether or not the correction color and the non-correction color conflict with each other will be described based on a flowchart in FIG. 8. The following procedure can be executed under control of the profile modifier.

The ICC profile is actually constituted by a multi-dimensional look-up table (LUT), which is illustrated here as a one-dimensional LUT. As illustrated in FIG. 6, in a case where the correction color and the non-correction color are interpolated by the common grid, both of the colors vary when the grid color is corrected.

At this time, instead of giving a correction amount of 100% to the grid that interpolates the correction color, a weight is designated on the basis of the grid interval and the interval between the correction color and the non-correction color in order to reduce the correction amount.

First, a correction color is designated (step s1). The correction color can be designated manually by the correction color specifier.

Subsequently, a non-correction color is designated (step s2). The non-correction color is specified by the non-correction color specifier. In the non-correction color specifier, the non-correction color may be automatically designated, in addition to manual designation of the non-correction color.

After the correction color and the non-correction color are designated, it is determined whether or not the correction color and the non-correction color conflict with each other (step s3).

When the correction color and the non-correction color do not conflict (step s3, No), a correction amount of 100% is given to the grid that interpolates the correction color, and the process is ended.

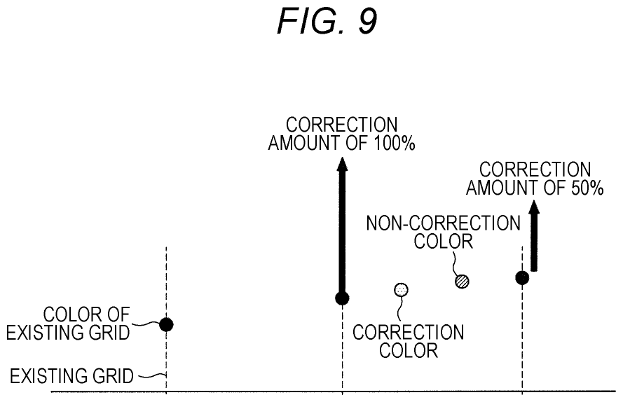

When the correction color and the non-correction color conflict with each other (step s3, Yes), the correction amount to be given to the grid that interpolates the correction color is reduced (step s5), and the process is ended. That is, in step s5, as illustrated in FIG. 9, the weight is designated on the basis of the grid interval and the relationship between the correction color and the non-correction color, such that the correction amount is reduced.

For example, if the weight is calculated with

weight=distance between closest grid and non-correction color/distance between grids,

½ is obtained when the distance between the non-correction color and the closest grid is 50% to the distance between the grids.

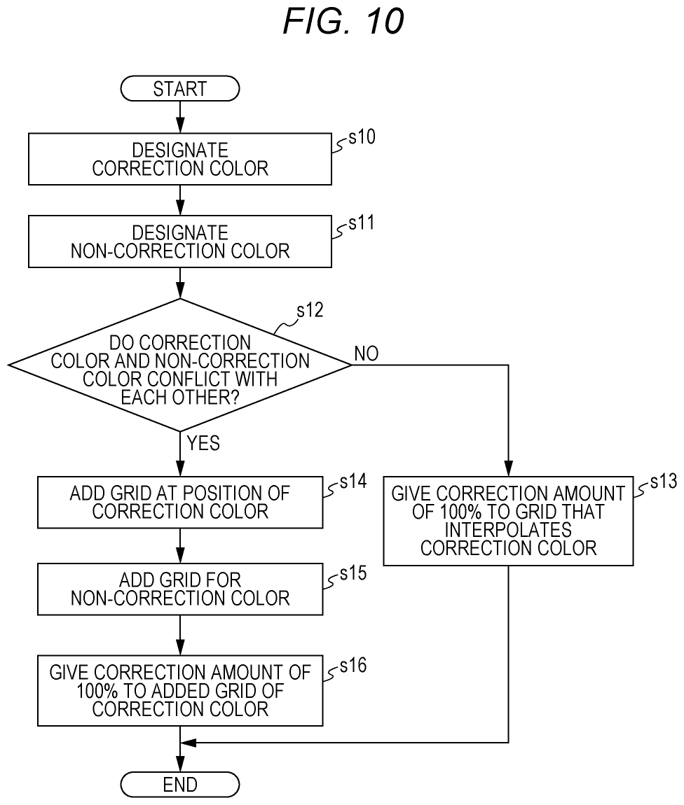

Next, a procedure for adjusting the number of grids when the correction color and the non-correction color conflict with each other will be described based on a flowchart in FIG. 10. The following procedure can be executed under control of the color conversion device.

First, a correction color is designated (step s10). The correction color is designated by the correction color specifier.

Subsequently, a non-correction color is designated (step s11). The non-correction color is designated by the non-correction color specifier.

After the correction color and the non-correction color are designated, it is determined whether or not the correction color and the non-correction color conflict with each other (step s12). When the correction color and the non-correction color do not conflict (step s12, No), a correction amount of 100% is given to the grid that interpolates the correction color (step s13), and the process is ended.

When the correction color and the non-correction color conflict with each other (step s12, Yes), a grid is added at the position of the correction color (step s14), and a grid for the non-correction color is added (step s15). The grid added to the position of the correction color is a first grid of the present invention, and the grid added for the non-correction color is a second grid of the present invention.

Subsequently, a correction amount of 100% is given to the added grid of the correction color, and the process is ended.

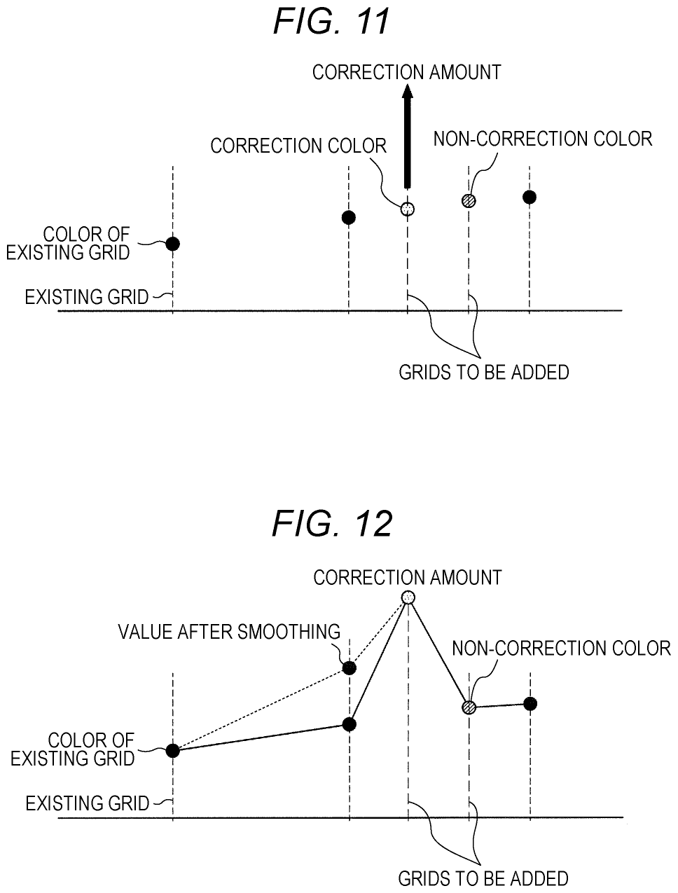

That is, when a conflict occurs as illustrated in FIG. 6, specifically, grids for the correction color and the non-correction color are added as illustrated in FIG. 11, and a correction amount of 100% is given to the correction color, while the current value is maintained for the non-correction color, whereby the correction color is selectively adjusted. In this mode, the number of grids is adjusted by adding the grids for the correction color and the non-correction color.

In addition, as illustrated in FIG. 12, by performing smoothing on the entire grids while maintaining the value of the corrected color, it is possible to perform tone jump caused by separation in value from the surrounding grids. Specifically, this procedure can be implemented by writing a value after the correction to the grid value again after carrying out the smoothing.

In the above mode, the number of grids is adjusted by adding grids for the correction color and the non-correction color; however, the number of grids may be adjusted by adding grids that interpolate the correction color and the non-correction color.

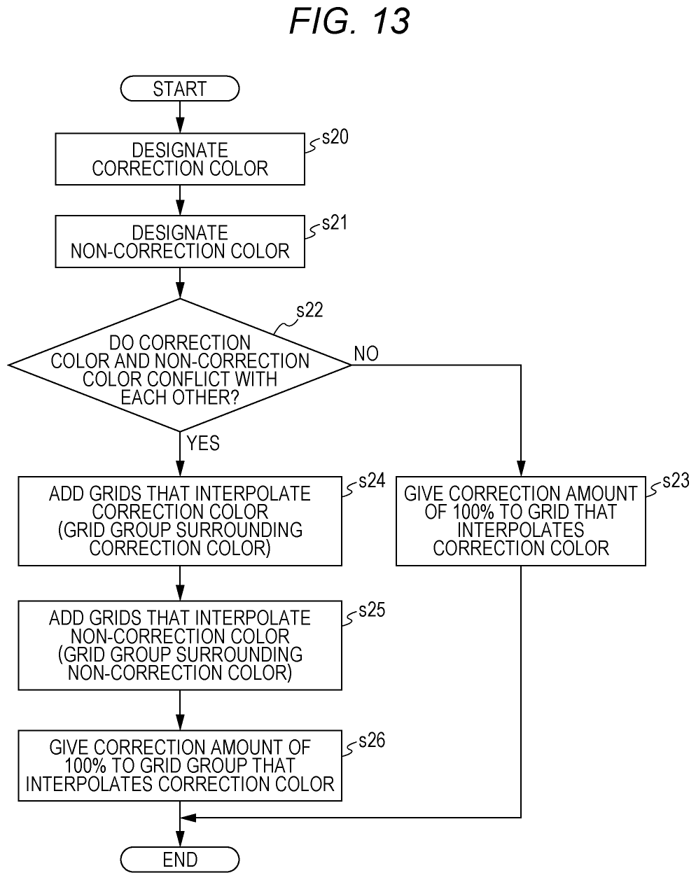

A procedure for adjusting the number of grids by adding grids that interpolate the correction color and the non-correction color will be described below based on a flowchart in FIG. 13. The following procedure can be executed under control of the color conversion device.

First, a correction color is designated (step s20). The correction color can be designated manually by the correction color specifier.

Subsequently, a non-correction color is designated (step s21). The non-correction color is specified by the non-correction color specifier. In the non-correction color specifier, the non-correction color may be automatically designated, in addition to manual designation of the non-correction color.

After the correction color and the non-correction color are designated, it is determined whether or not the correction color and the non-correction color conflict with each other (step s22).

When the correction color and the non-correction color do not conflict (step s22, No), a correction amount of 100% is given to the grid that interpolates the correction color (step s23), and the process is ended.

When the correction color and the non-correction color conflict with each other (step s22, Yes), grids that interpolate the correction color (a grid group surrounding the correction color) are added (step s24), and grids that interpolate the non-correction color (a grid group surrounding the non-correction color) are added (step s25). Subsequently, a correction amount of 100% is given to the added grid group of the correction color (step s26), and the process is ended.

Note that the grids that interpolate the correction color correspond to a first grid group of the present invention, and the grids that interpolate the non-correction color correspond to a second grid group of the present invention.

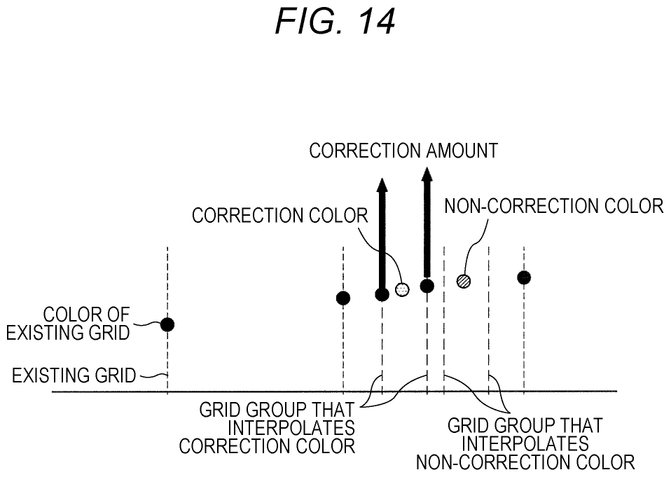

That is, when a conflict occurs as in FIG. 6, a grid group that interpolates the correction color and a grid group that interpolate the non-correction color are individually added, and a correction amount of 100% is given to the grid group that interpolates the correction color, while the current value is maintained for the grid group that interpolates the non-correction color, whereby the correction color is selectively adjusted (see FIG. 14).

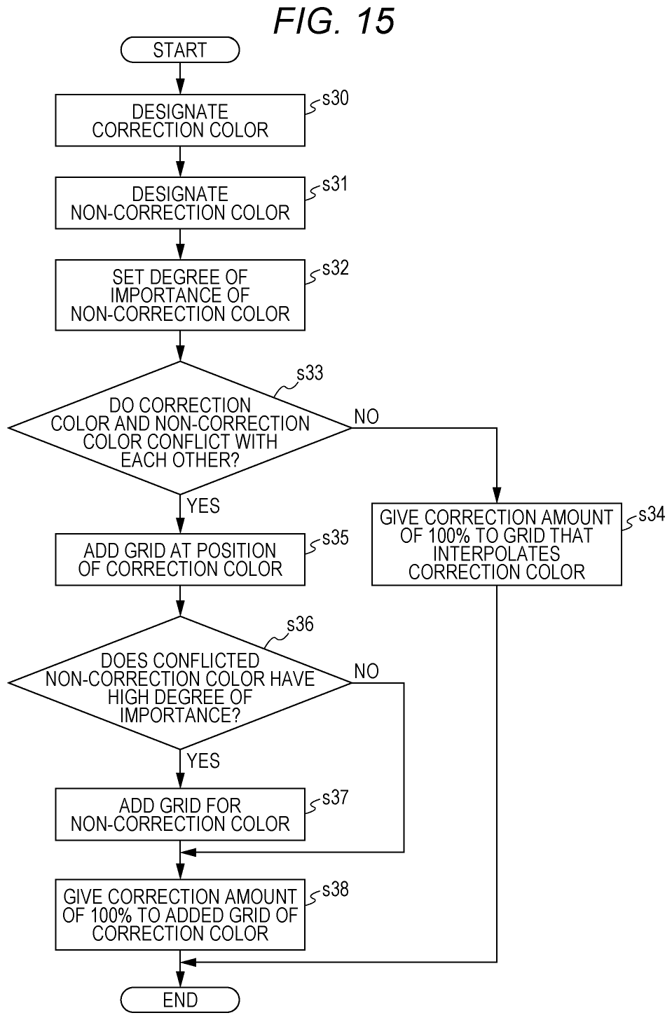

Note that whether or not the grid is added can be designated according to additional information associated with the non-correction color. A procedure in a case where the additional information is the degree of importance will be described below based on a flowchart in FIG. 15. The following procedure can be executed under control of the color conversion device.

First, a correction color is designated (step s30). The correction color is designated by the correction color specifier.

Subsequently, a non-correction color is designated (step s31); the non-correction color is designated by the non-correction color specifier. Furthermore, the degree of importance of the non-correction color is set (step s32). The degree of importance of the non-correction color can be set by the non-correction color specifier.

Thereafter, it is determined whether or not the correction color and the non-correction color conflict with each other (step s33). When the correction color and the non-correction color do not conflict (step s33, No), a correction amount of 100% is given to the grid that interpolates the correction color (step s34), and thereafter the process is ended.

When the correction color and the non-correction color conflict with each other (step s33, Yes), a grid is added at the position of the correction color (step s35), and it is determined whether or not the conflicted non-correction color has a high degree of importance (step s36). Whether the degree of importance is high may be determined depending on whether a high degree of importance has been set; when the degree of importance is set by a numerical value, a threshold value may be set beforehand such that whether the degree of importance is high is determined according to whether or not the threshold value is exceeded. The grid added at the position of the correction color corresponds to the first grid of the present invention.

When the degree of importance of the non-correction color is not high (step s36, No), a correction amount of 100% is given to the added grid of the correction color (step s38), and thereafter the process is ended. When the degree of importance of the non-correction color is high (step s36, Yes), a grid for the non-correction color is added (step s37). The grid for the non-correction color corresponds to the second grid of the present invention. Subsequently, a correction amount of 100% is given to the added grid of the correction color (step s38), and then the process is ended.

Since adding too many grids is sometimes disadvantageous in terms of calculation cost and tonality, there are cases where the addition of the number of grids needs to be limited. For this reason, the degree of importance is set for the specified or automatically detected non-correction color.

For example, when the degree of importance is classified into “high” and “low” and “high” is specified, the grid is always added and the value is maintained; however, in the case of “low”, whether to add can be found out in accordance with the situation of the number of grids.

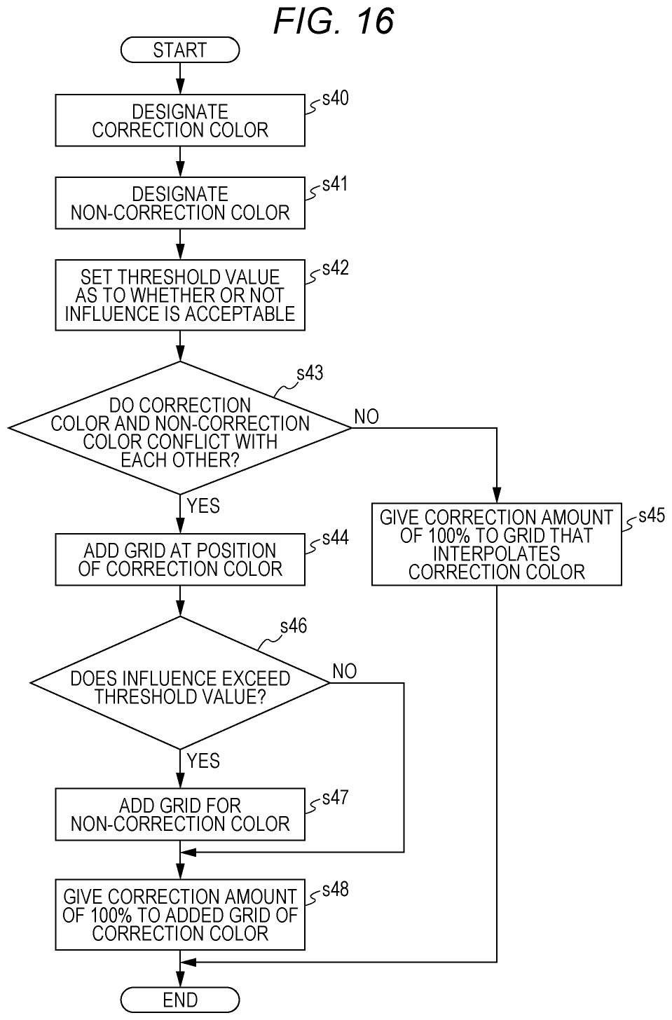

Next, a procedure for performing the process by setting a threshold value as to whether or not the influence given by the correction color is acceptable will be described based on a flowchart in FIG. 16. The following procedure can be executed under control of the color conversion device.

First, a correction color is designated (step s40). The correction color is designated by the correction color specifier.

Subsequently, a non-correction color is designated (step s41); the non-correction color is designated by the non-correction color specifier. Furthermore, a threshold value as to whether or not the influence of the correction color is acceptable is set. The threshold value can be set by a threshold value setter. In addition, the threshold value setter may be included in the correction color specifier or the non-correction color specifier.

Thereafter, it is determined whether or not the correction color and the non-correction color conflict with each other (step s43). When the correction color and the non-correction color do not conflict (step s43, No), a correction amount of 100% is given to the grid that interpolates the correction color (step s45), and thereafter the process is ended.

When the correction color and the non-correction color conflict with each other (step s43, Yes), a grid is added at the position of the correction color (step s44), and it is determined whether or not the influence exceeds the threshold value (step s46). The grid added at the position of the correction color corresponds to the first grid of the present invention.

When the influence does not exceed the threshold value (step s46, No), a correction amount of 100% is given to the added grid of the correction color (step s48), and thereafter the process is ended.

When the influence exceeds the threshold value (step s46, Yes), a grid for the non-correction color is added (step s47). The grid added for the non-correction color corresponds to the second grid of the present invention. Subsequently, a correction amount of 100% is given to the added grid of the correction color (step s48), and thereafter the process is ended.

That is, the influence of the correction color on the non-correction color is calculated, and the grid is not added when the calculated value is within the set threshold value, while the grid is added when the threshold value is exceeded.

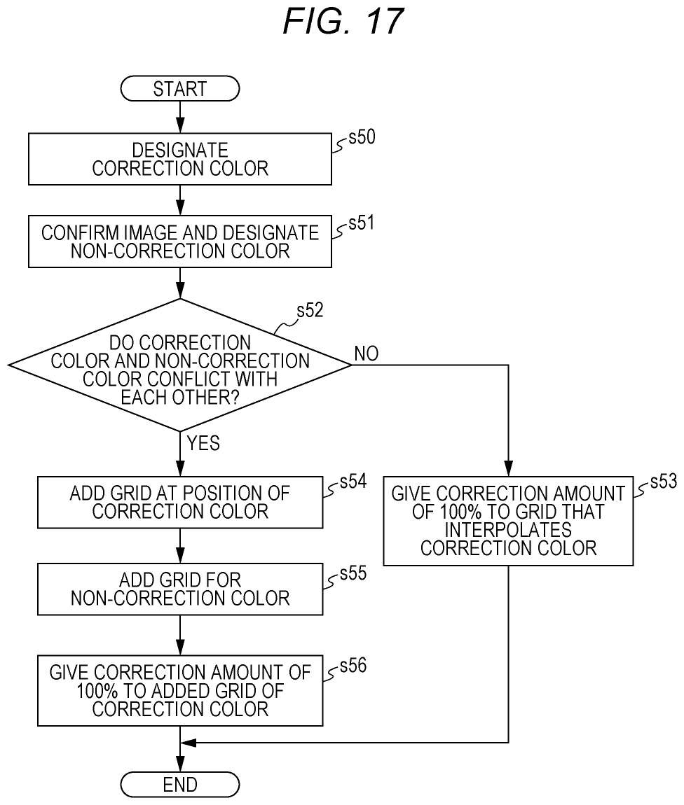

Next, a procedure for designating the non-correction color from information in an image will be described based on a flowchart in FIG. 17. The following procedure can be executed under control of the color conversion device.

First, a correction color is designated (step s50). The correction color is designated by the correction color specifier.

Subsequently, the image is confirmed and a non-correction color is designated (step s51).

Furthermore, it is determined whether or not the correction color and the non-correction color conflict with each other (step s52). When the correction color and the non-correction color do not conflict (step s52, No), a correction amount of 100% is given to the grid that interpolates the correction color (step s53), and thereafter the process is ended.

When the correction color and the non-correction color conflict with each other (step s52, Yes), a grid is added at the position of the correction color (step s54), and a grid for the non-correction color is added (step s55).

A correction amount of 100% is given to the added grid of the correction color (step s56), and thereafter the process is ended.

The added grid of the correction color corresponds to the first grid of the present invention, and the grid added for the non-correction color corresponds to the second grid of the present invention.

It is time-consuming and difficult for the user to uniquely find out a color that causes tone jump if changed in the image or a color that breaks the impression of the image, and to specify such a color as a non-correction color. For this reason, the non-correction color needs to be designated even if the user does not specify the non-correction color.

Since a color with larger color distributions in an image or a larger area is often the color that affects the impression of the image, the value can be maintained by acquiring all the values of respective pixels of the image, confirming the distribution, and extracting a color with larger color distributions as a non-correction color.

In addition, a region in which pixels of near colors are continuous is identified in the image and the area of the region is calculated. The value can be maintained by extracting a color used for the region having a larger area as a non-correction color.

By comparing the values of adjacent pixels in the image, gradation or a dense region of colors having near values is located and, when such colors are included in the influence range of the correction color, the values can be maintained by extracting such colors as non-correction colors.

Additionally, in general, it is sometimes preferred that mixing of a different color into a single color (such as cyan only) be suppressed during printing. For this reason, contamination removal can be set. In this case, when the single color is contained in the influence range of the correction color, the value can be maintained by extracting the single color as a non-correction color.

About how to Use Profile after Correction

The correction of the profile can be carried out, for example, within the specifications of the ICC profile, and the profile after the correction can be processed by a general color management system (CMS). The correction color is subjected to color conversion using the added grid, and the output close to a targeted value that has been specified or automatically calculated is obtained.

According to an embodiment of the present invention, the effect of correcting a color desired to be corrected into an expected correction value, and reducing the influence on or not correcting a color not desired to be corrected can be obtained.

Although embodiments of the present invention have been described and illustrated in detail, the disclosed embodiments are made for purposes of illustration and example only and not limitation. The scope of the present invention should be interpreted by terms of the appended claims Any modifications can be made to the above embodiments as appropriate without departing from the scope of the present invention.

What is claimed is:

1. A color conversion device that applies a profile to a target image to perform color conversion,
the color conversion device comprising a hardware processor that receives specification of a color to be corrected in a target image, adjusts the color that has been specified in a profile, and modifies an adjustment amount for surroundings of the color that has been specified, in accordance with the target image.

2. The color conversion device according to claim 1, further comprising a correction color specifier that specifies a color to be corrected in the target image.

3. The color conversion device according to claim 1, wherein the hardware processor receives specification of a non-correction color not to be corrected, determines whether or not a correction color and the non-correction color conflict with each other in an influence range of correction, and reduces an adjustment amount to be given to a grid that interpolates a color desired to be corrected when determining that the correction color and the non-correction color conflict with each other.

4. The color conversion device according to claim 1, wherein the hardware processor receives specification of a non-correction color not to be corrected, determines whether or not a correction color and the non-correction color conflict with each other in an influence range of correction, and supplies a correction amount after adjusting the number of grids in a profile used for color conversion when determining that the correction color and the non-correction color conflict with each other.

5. The color conversion device according to claim 3, wherein the hardware processor corrects the profile by adding a first grid at a position of the correction color, supplying a correction amount to the first grid, adding a second grid for the non-correction color, and narrowing the influence range to a color that has been specified, by maintaining an original value of the second grid.

6. The color conversion device according to claim 3, wherein the hardware processor corrects the profile by adding a first grid group at positions surrounding the correction color, supplying a correction amount to the first grid group, further adding a second grid group for the non-correction color, and narrowing the influence range to a color that has been specified, by maintaining original values of the second grid group.

7. The color conversion device according to claim 5, wherein the hardware processor determines whether to add a grid as a non-correction color in accordance with additional information on the non-correction color.

8. The color conversion device according to claim 7, wherein
a non-correction color specifier is capable of setting a degree of importance of the non-correction color as the additional information, and
the hardware processor determines whether to add a grid as a non-correction color in accordance with the degree of importance.

9. The color conversion device according to claim 4, further comprising a threshold value setter that sets a threshold value of a correction amount to determine whether to add a grid for the non-correction color, wherein
the hardware processor does not add a grid for a specified non-correction color or a determined non-correction color when an adjustment amount of the correction color is within the threshold value.

10. The color conversion device according to claim 1, further comprising a non-correction color specifier that specifies a non-correction color not to be corrected.

11. The color conversion device according to claim 1, wherein the hardware processor confirms a color used in an image, and designates a non-correction color in accordance with a result of the confirmation.

12. The color conversion device according to claim 11, wherein
when confirming a color in an image,
the hardware processor analyzes distribution of colors used in the image, confirms whether or not a color with a higher number of appearances is included in an influence range of a correction color, and determines the color with a higher number of appearances as a non-correction color when the color with a higher number of appearances is included in the influence range.

13. The color conversion device according to claim 11, wherein
when confirming a color in an image,
the hardware processor confirms an area of an object used in the image, confirms whether or not a color used for the object with a larger area is included in an influence range of a correction color, and determines the color used for the object with a larger area as a non-correction color when the color used for the object with a larger area is included in the influence range.

14. The color conversion device according to claim 11, wherein
when confirming a color in an image,
the hardware processor confirms an appearance location of a color used in the image, confirms whether or not a color of which an appearance location is used in gradation or in a region where colors having near values are densely laid out is included in an influence range of a correction color, and determines the color at the appearance location as a non-correction color when the color at the appearance location is included in the influence range.

15. The color conversion device according to claim 11, wherein
when confirming a color in an image,
in a case where contamination removal is set in the profile, the hardware processor confirms whether or not a single color is included in an influence range of a correction color, and determines the single color as a non-correction color when the single color is included in an influence range.

16. The color conversion device according to claim 1, further comprising a display part that displays an image to be adjusted.

17. A color conversion method that applies a profile to a target image to perform color conversion, the color conversion method comprising:
specifying a color to be corrected in a target image; and
adjusting the color that has been specified in a profile, and modifying an adjustment amount for surroundings of the color that has been specified, in accordance with the target image.

18. The color conversion method according to claim 17, further comprising:
specifying a non-correction color not to be corrected; and
determining whether or not a correction color and the non-correction color conflict with each other in an influence range of correction, and reducing an adjustment amount to be given to a grid that interpolates a color desired to be corrected when it is determined that the correction color and the non-correction color conflict with each other.

19. The color conversion method according to claim 17, further comprising:
specifying a non-correction color not to be corrected; and
determining whether or not a correction color and the non-correction color conflict with each other in an influence range of correction, and supplying a correction amount after adjusting the number of grids in a profile used for color conversion when it is determined that the correction color and the non-correction color conflict with each other.

20. A non-transitory recording medium storing a computer readable color conversion program executed by a hardware processor of a color conversion device that applies a profile to a target image to perform color conversion,
the program causing the hardware processor to execute adjusting a color that has been specified in a profile, and modifying an adjustment amount for surroundings of the color that has been specified, in accordance with the target image.

21. The non-transitory recording medium storing a computer readable color conversion program according to claim 20, the program further causing the hardware processor to execute determining whether or not a correction color and a non-correction color conflict with each other in an influence range of correction, and reducing an adjustment amount to be given to a grid that interpolates a color desired to be corrected when it is determined that the correction color and the non-correction color conflict with each other.

22. The non-transitory recording medium storing a computer readable color conversion program according to claim 20, the program further causing the hardware processor to execute determining whether or not a correction color and a non-correction color conflict with each other in an influence range of correction, and supplying a correction amount after adjusting the number of grids in a profile used for color conversion when it is determined that the correction color and the non-correction color conflict with each other.
